(19) United States
(12) Patent Application Publication
(10) Pub. No.: US 2023/0130207 A1
(43) Pub. Date: Apr. 27, 2023

(54) Naturally Biodegradable Cup for Powdered Cosmetics

(71) Applicants: Seneca Fox Miller, Pettisville, OH (US); Luke Patrick Miller, Pettisville, OH (US)

(72) Inventors: Seneca Fox Miller, Pettisville, OH (US); Luke Patrick Miller, Pettisville, OH (US)

(21) Appl. No.: 17/508,025

(22) Filed: Oct. 22, 2021

(51) Int. Cl. A45D 33/00; B65D 1/24

(52) U.S. Cl. CPC A45D 33/003; B65D 1/24; B65D 65/466

(57) ABSTRACT

A biodegradable cosmetic empty is provided, made from molded fiber for the direct receipt and containment of powder cosmetic via compaction to form a cosmetic pan. The embodiments of the invention present a variety of structural principles that prevent product buckling during compaction, protect against damage to the cosmetic during use, and allow easy use of the pan in cosmetic palettes. The implementation of the claimed invention will dramatically reduce plastic and metal waste in the cosmetic industry. The molded fiber must derive from virgin, cellulosic fibers to prevent contamination of the cosmetic.

### TECHNICAL FIELD OF INVENTION

Biodegradable products and cosmetics.

### CROSS-REFERENCED/RELATED APPLICATIONS

N/A

### PRIORITY CLAIM TO EARLIER DATE

N/A

### STATEMENT ABOUT FEDERAL SPONSORSHIP

No federal-sponsored research or development was involved in this invention.

### STATEMENT OF PRIOR PUBLIC DISCLOSURE

On November 12^{th}, 2020 Seneca Miller gave an academic presentation in an entrepreneurship class at Concordia University Ann Arbor. The presentation included a video in which Seneca referred to plans to use molded fiber “inserts” containing cosmetic powder.

Other than this November 12^{th} disclosure, no other public disclosures have been made.

### DESCRIPTION OF RELATED PRIOR ART

### Patents

A prior art search by Rabbit Product Design Company was performed, and no patents were found that disclose our claimed invention. The list of searched patents is included here: https://docs.google.com/spreadsheets/d/lt5_EBEtnO74KwOD9_u5lM-CkY5QDMeNQQNqD-OV4Kc4/edit#gid=27065669

The closest patent found was U.S. 10,961,044 B2, which covered a biodegradable package for storing eggs. This patent differs from the claimed invention for many reasons, but we have listed the main three below.
1. The 10,961,044 patent holds eggs, and the claimed invention is an empty cup used to manufacture cosmetic “pans” (a pan is defined in the background of the invention in the specification). These uses and purposes are extremely different and not related.
2. The 10,961,044 patent is a container that shields its contents (eggs) from exterior damage. The claimed invention is utterly different and uses molded fiber to form, strengthen, and bind a powdered cosmetic into a cosmetic pan. By doing so, the claimed invention becomes part of the cosmetic product itself. This is different from a mere “holder” that transports its egg cargo.
3. 10,961,044 patent is a loose-fitting outer packaging that holds its cargo without attaching or adhering to them in any way. The claimed invention’s molded fiber binds to powdered cosmetics on a molecular level, preventing the cosmetic power from falling out of the pan. Therefore, the way the claimed invention holds its cargo is fundamentally different than the 10,961,044 patent.

### Other Products

Other products that are tangentially related are the molded fiber cosmetic packaging by Golden Arrow and “Fibreform” Planet Revolution Palette by Revolution Beauty UK. The aspects of our invention that distinguish the claimed invention from each are discussed below.

### Golden Arrow

The Golden Arrow product is a molded fiber palette, not a pan. This means its primary purpose is to store makeup pans, not the makeup powder alone. It uses metal pans that are not biodegradable to hold the cosmetic powders.

The claimed invention is a pan, not a palette. These pans fit into customizable palettes and each contains individual cosmetics formulations. This is accomplished by the direct pressing of cosmetic powder into molded fiber receptacles, a process that has never been done before. The compaction of cosmetics directly into molded fiber requires careful design of the shape of the pan and the pressing process. Consumers cannot use these pans as cosmetics by themselves.

https://www.goldenarrow.com/luxury-cosmetics-packaging

### Revolution Beauty

Revolution Beauty released a “FibreForm” biodegradable palette in January 2021. This palette is a single piece of biodegradable material that holds numerous different powdered cosmetics in a pallet format. The “FibreForm” pallet is made from a material that mimics the look and feel of plastic.

The primary differences between the Revolution Beauty product and the claimed invention are three-fold.
1. The Revolution Beauty product is a single-piece cosmetic pallet, while the claimed invention is a cosmetic pan.
   a. The Revolution Beauty product is a complete palette for use by itself. This means the product is a single molded piece of Fibreform that contains, stores, and presents the cosmetics for customer use. It makes no use of individual cosmetic pans but instead holds the cosmetic powders within compartments of the pallet frame itself. Palettes are a complete cosmetic set used by consumers.
   b. The claimed invention is a cosmetic pan. These pans fit into customizable palettes and each contains individual cosmetics formulations. Consumers cannot use these pans as cosmetics by themselves.
2. Revolution Beauty’s product is made out of a biodegradable plastic mimic. This material has the same limitations that make metal the preferred material for cosmetic empties. The claimed invention uses molded fiber to make its pans. This molded fiber is resilient enough to survive the forces of cosmetic powder presses without deforming or cracking like plastic would. This is true despite molded fibers being much thinner than the thickness needed to make Revolution Beauty’s plastic mimic strong enough for pressing.
3. Molded fiber pans degrade faster than Revolution Beauty’s plastic mimic, making this claimed invention better for the environment.

https://www.revolutionbeauty.us/revolution-beauty-planet-revolution-revolutionary-bare-marble-shadow-palette/13125065 .html?affil=thggpsad&switchcurrency=USD&shippingcountry=US&gclid=CjwKCAjwn 8SLBhAyEiwAHNTJbb7kMfcfEhH6WfNttzQ5YzNpK4N5hc4GXhh8-FLylFT41MeDpr4OdRoCG78QAvD _BwE&gclsrc=aw.ds

### BACKGROUND OF INVENTION

The beauty industry produces billions of plastic packaging units every year, resulting in millions of tons of plastic waste. This packaging is a primary driver of plastic production, contributing to a global waste crisis. In response, rising consumer awareness and concern for the environment is driving demand for more environmentally conscious products.

Pressed powder cosmetics are one sector of the beauty industry that is attempting to reduce its packaging waste. Pressed powder cosmetics are produced by mixing dry colorizing and texturizing powders with a binding agent and compressing the powders into pans made of plastic or metal. Filled pans are also referred to in the industry as “pans.” To prevent confusion hereafter, we will refer to a container filled with cosmetic powder as a “pan” and an unfilled container as an “empty.” These pans are then fixed in grid-like palettes and sold to consumers. Most palettes are plastic and single-use, meaning once a consumer has used up the desired color(s), they dispose of the entire palette. Since palettes usually also contain metal components, they must be disposed of in landfills, where they can take tens to hundreds of years to decompose. Many companies have introduced alternatives to this wasteful model. Some have replaced plastic palettes with paper material; others designed customizable palettes that reuse the palette frame, discarding the used empty and obtaining new ones to be inserted in their place. While both innovations somewhat reduce consumer waste, the remaining waste is still a significant problem for the beauty industry.

One ongoing source of waste in cosmetics are the empties into which powder makeup is pressed to form a pan. While metal empties are recyclable, makeup recycling is not widely practiced. This is due to the metal empties often being fixed to paper or plastic in single-use palettes, which must be separated and sorted by the consumer prior to recycling.

Furthermore, in the case of replaceable units, the limited availability of recycling centers in many geographic areas makes simply disposing of the empty in garbage more appealing to the consumer than recycling. There have been a few initiatives to aid consumers in recycling their packaging and a few cosmetic companies offer reuse programs, where used empties are sterilized and re-filled. However, these re-usable systems rely on an engaged and concerned consumer willing to make the effort to return or recycle their used empties. Because there is a significant population of consumers who have no interest in recycling, the scalability of these existing approaches is limited.

Naturally biodegradable materials have become increasingly promising as a means of reducing waste in the beauty industry. Naturally biodegradable materials must be single-use; their lack of durability is precisely what makes them easily decomposable by the environment. Furthermore, while both composting and recycling are preeminently desirable, recycling requires energy and both processes result in the release of greenhouse gases. Maximizing reduction and reuse are preferable to maximizing recycling. Therefore, the optimum system for reducing waste maximizes reusable and refillable materials while minimizing the mass of material that must be composted or recycled.

Metal empties are the standard due to their high rigidity and resilience. Compressing the cosmetic into a pan usually requires high pressures which few materials are able to withstand without cracking or warping. Metal possesses the required rigidity to resist warping under pressure, and the resilience to return to its desired shape if small warps occur. On the other hand, plastic is a much weaker material, so it cannot be used in the same way as metal empties. Plastic empties are much more thickly walled and usually built into the palette itself before compaction.

Metal and plastic empties have also been shown to prevent damage during the life of the cosmetic. A quality pressed powder cosmetic must maintain pan integrity, which is the pristine visual appearance of the makeup in the pan. Chipping, cracking or other damage to the cosmetic powder can dirty the palette, contaminate other colors, and ruin the visual appeal of the cosmetic. Damage to a pan can occur due to rough handling or dropping, common occurrences in the life of the makeup. Furthermore, such damage weakens the pan, increasing the likelihood of further distress to the cosmetic. If the compacted pellet is sufficiently damaged, expulsion of the makeup pellet from the pan can result, rendering the makeup completely unusable. These damaged pans increase both customer dissatisfaction and the number of cosmetics that must be refunded or replaced, which negatively impacts cosmetic company profits.

Distressed makeup pans are usually a sign of a low-quality makeup formula. However, an insufficiently strong makeup empty can lead to similar breakages. Thus, there has been little incentive to pursue alternative empty materials, since sacrificing the rigidity of the pan can make a high-quality cosmetic formulation appear inferior.

Moreover, the current state of art relies almost exclusively on a fixed fit model to hold the pan in a palette. A fixed fit refers to the degree of clearance within an assembly mating two parts in which the clearance is so small as to hold the male part in place solely via the pressure exerted by the walls of the female part onto those of the male (FIG. 1). Currently, the only alternative to fixed fit relies on magnetic forces to keep pans in place, which are equally reliant on metal materials.

The high rigidity of plastic and metal empties prevents their buckling under the strain of palette mating because that strain would otherwise result in cracking or other deformation of the pan. The risk of pan deformation is exacerbated in customizable palettes (palettes with replaceable pans) because replacements are performed by the consumer, who is more liable to error and damage the pans. For example, if a consumer is replacing a pan in a palette, and applies an uneven force to the pan, the customer will likely break the pan and demand a refund from the cosmetic company.

The risk of pan breakage increases inversely to the rigidity of the material that constitutes the empty. Historically, biodegradable substances have not been used in pressed-powder pans because they have been insufficiently rigid to withstand the forces exerted upon them by the current state of art’s employment of the fixed fit system.

Furthermore, promising biodegradable materials such as molded fiber, while highly adaptable, have suffered from draft angles and unit volume constraints. Draft angles are a manufacturing requirement for a variety of materials, especially those shaped via molds. They allow parts to be more easily separated from their molds and also can help increase a part’s stability. However, fixed fits usually rely on matings which have no draft angle, since the force vector between a wall that is not parallel to the axis of insertion will have a component vector oriented outward. This greatly increases the likelihood of the expulsion of the male part in a fixed fit mating (FIG. 1). Maintaining a fixed fit in cosmetic packaging has been doubly important because not only is the pan usually held in the palette via fixed fit, but the cosmetic powder is held in the empty in a manner analogous to a fixed fit as well. Thus, not only is the pan’s storage in a palette jeopardized, but the integrity of the pan itself is also.

Molded fiber is traditionally made from recycled paper, which is pulverized and mixed with water to form a slurry. This slurry is then formed to a mold via suction and heated to evaporate the water from the pulped fiber. What remains is a rigid interweaving of starch and/or cellulosic fibers. Thermoformed molded fiber is formed via a two-press procedure in which an initial mold collects and forms the slurry into a general shape, which is then hot-pressed into a more exact form. This allows thermoformed molded fiber to include thinner and denser walls, more precise shapes, and lower draft angles.

Furthermore, while recycled paper is a typical substrate, other “virgin fiber” substrates have also been shown to be effective. This includes the by-products of agro-industrial processes. One such process is the refinement of sugar, which produces sugar cane pulp (hereafter referred to as “bagasse”). Other virgin fibers include but are not limited to wood and bamboo pulp. These fibers have the benefit of being free of chemical contaminants, such as inks from recycled newspaper, a common source of raw material for molded fiber packaging. The use of virgin fibers makes molded fiber much more suitable for cosmetic usage, since there are no contaminants that could leach into the cosmetic product.

A common substrate for packaging applications, molded fiber is employed as secondary packaging, acting as a cushioning agent for fragile cargo. In addition, it has in limited cases been developed as an eco-friendly alternative to plastic palettes. Furthermore, molded fiber has always been designed to conform to the product that it is packaging, never vice versa. Molded fiber has also never served as the primary container of pressed powder makeup, meaning it is the object into which the powder cosmetic is compressed.

### BRIEF SUMMARY OF INVENTION

The embodiment of this invention is a container made out of molded fiber for the direct containment of cosmetic powder via compression forming a makeup pan.

The naturally biodegradable (and compostable) aspect of the invention is useful because it eliminates lasting environmental waste once a consumer disposes of the empty. This eliminates a significant hurdle to realizing a truly zero consumer waste makeup product. Furthermore, the environmental benefits are scalable because it repurposes common agro-industrial wastes and renders a limited-to-no burden on consumers for proper disposal.

Another aspect of the invention is the introduction of structural features that improve the integrity of the pan. The invention circumvents the problem of molded fiber’s relatively low rigidity via the invention’s design. Testing and analysis have found that thermoformed, virgin molded fiber provides an unexpectedly strong option for the production of completely biodegradable pans.

A final aspect of the invention is its adaptability to reduce the waste of a variety of palette designs, including single-use paper or refillable cosmetic palettes. Moreover, the incorporation of an outward-facing lip into the design both improves compression outcomes and creates a face free from cosmetic powder to secure the pan in-palette. It also allows for the creation of a multicompartment pan for more seamless integration into a palette.

### DESCRIPTION OF INVENTION DRAWINGS

FIG. 1: illustrates the forces at play between two surfaces in a fixed fit model. In the Diagram, A is the male part and B is the female part. The walls of B exert a force (F_{f}) on the walls of A. When the walls have no draft angle (left) the full force is exerted horizontally (F_{f}= Fₕ). However, when the draft angle is non-zero, there is a vertical component (Fᵥ) to F_{f} such that Fᵥ > 0. This force promotes the ejection of the male part from the female.

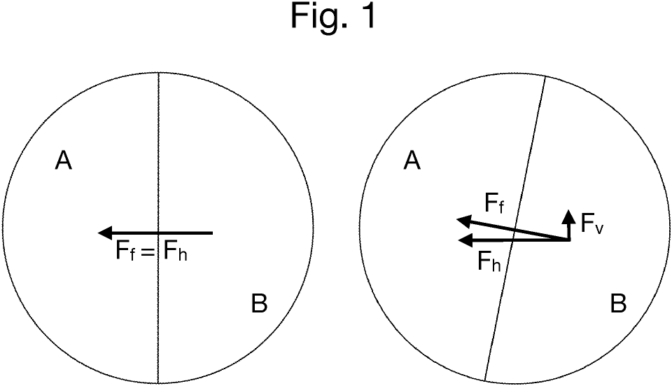

FIG. 2: presents a perspective view of the hexagonal design (1a) of the biodegradable empty.

FIG. 3: presents a front view of (1a).

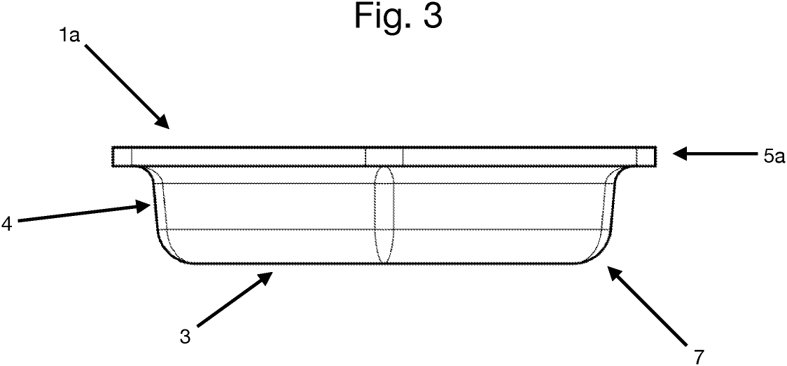

FIG. 4: presents a perspective view of the circular design (1b) featuring the large-face stabilizing groove (8).

FIG. 5: presents a front section view of (1b) filled with cosmetic.

FIG. 6: presents a perspective view of a square, multi-compartmented design (1c) featuring a lip adapted for fixed fit integration (5b).

FIG. 7: presents a blown out view of (1a) interacting with generic clamp (9) to demonstrate a method for securing the container lip (5a) via pinching.

FIG. 8: presents a blown out view of (1c) interacting with generic box (10) to demonstrate a method for securing the container lip (5b) via adapted fixed fit.

FIG. 9: illustrates the force of friction between the wall of the molded fiber container (4) and the pressed powder pellet (6). The force of friction exerted by the textured surface on the pellet (Fₜ) is much higher than that exerted by a smooth surface (Fₛ).

FIG. 10: illustrates how the lip of the molded fiber empty reduces the shear force (Fₐ) on the walls of the container during the powder compaction process, distributing them more evenly (B) and preventing buckling of the container wall.

### DESCRIPTION OF INVENTION

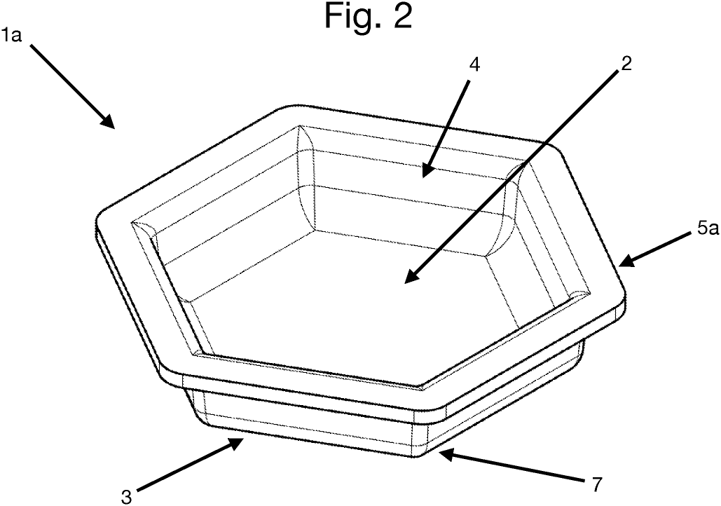

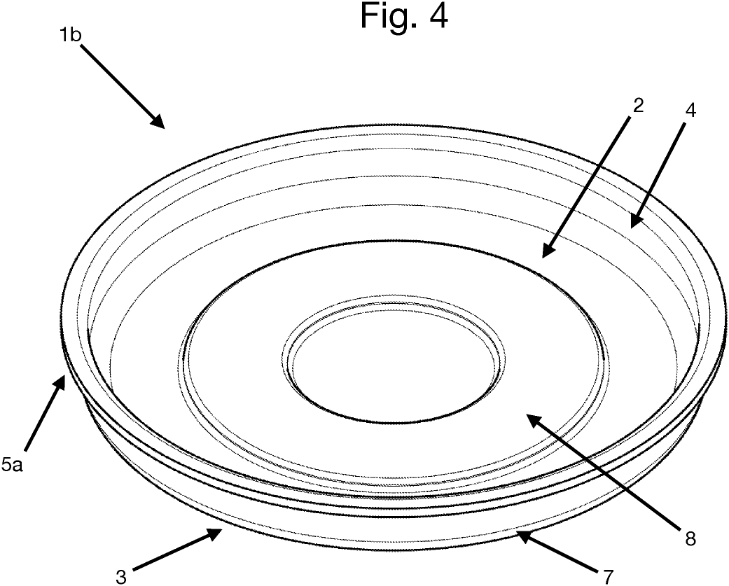

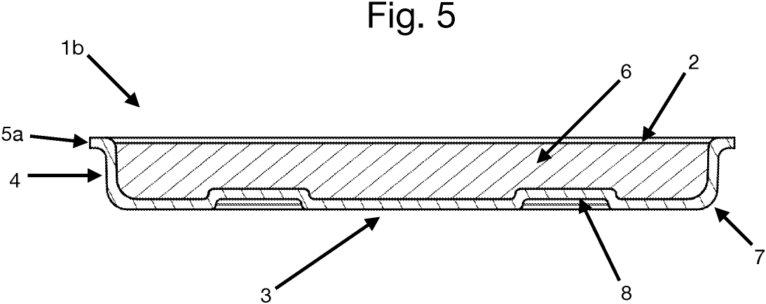

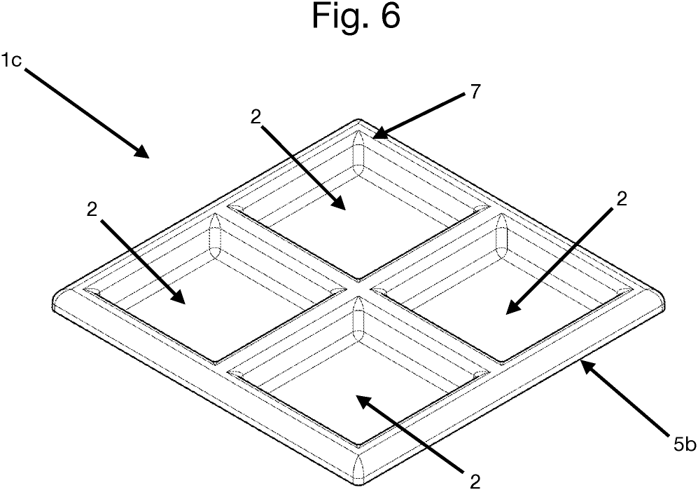

This invention is a makeup container or “empty” made from molded fiber (1), the base of the container (3) transitions via rounded corners (7) into drafted walls (4) that terminate in an outward-facing lip (5). The empty may be a single compartment (FIGS. 2, 4) or feature multiple compartments joined together (FIG. 6). The container receives the direct compression of cosmetic powder (6) into its compartment (2) up to or just below the plane of the lip (FIGS. 5, 7, 8). The compacted cosmetic powder itself will hereafter be referred to as a “pellet.”

Molded fiber was selected for this product due to its low environmental impact and superior adaptability. Its adaptability allows it to be engineered into shapes and structures that maximize the strength of the container, even though molded fiber is a very thin packaging material. Crucially, molded fiber is highly resilient, so it does not permanently deform or crack under the pressure conditions necessary for cosmetic powder compaction. It is commonly believed and asserted in the cosmetic industry that high rigidity and resilience (unless compensated by wall thickness) are both necessary properties of an empty.

However, the claimed invention defies this widespread industry belief. Despite molded fiber possessing a minimum degree of rigidity, the fiber’s extreme resilience allows it to withstand the compaction process without damage. This unexpected result of molded fiber’s resilience allows the molded fiber to make an effective cosmetic pan. Among the different types of molded fiber materials, thermoformed molded fiber, especially, is the most effective material for cosmetic pans due to its high strength, capability of precise structural features, low draft angle requirements, and minimal part volume constraints.

Cellulosic fiber is preferred because of its superior structural integrity. Natural sources of cellulosic fiber are preferred including but not limited to bagasse, bamboo fiber, wood fiber, coconut fiber, or wood fiber. These starting materials are obtainable from the waste of agro-industrial processes, decreasing the environmental cost of procurement. It is very important that any source of fiber be highly pure since chemical transfer from the fiber to the cosmetic via the binding agent is possible. The inclusion of any detectable contaminants not approved for cosmetic use by the FDA constitutes a potential hazard to the consumer.

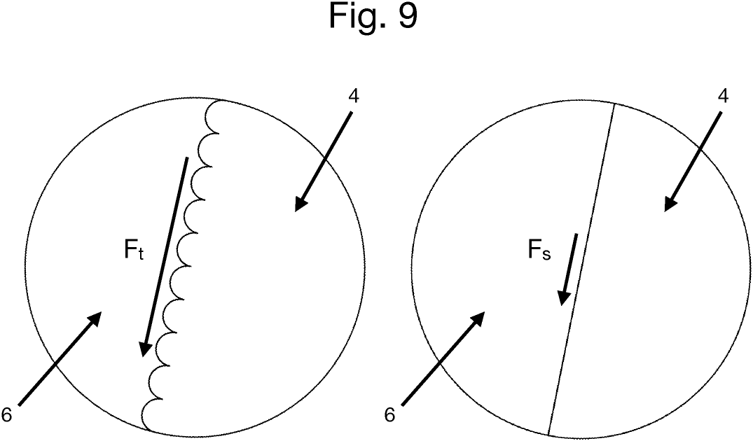

Molded Fiber pans are more susceptible to forces causing flexion of their walls (4) than their metal counterparts. In extreme cases, this can cause cracking, chipping, or expulsion of the cosmetic powder from the pan (loss of pan integrity). For this reason, previous cosmetic companies have actively avoided using molded fibers in pans. We found that this problem is countered by texturing the interior surface of the molded fiber (FIG. 9). This textured surface on the inside of the empty creates a rough face for contact with the cosmetic powder (6). The compaction of the cosmetic powder forms it into a single pellet with rough edges complementary to the surface of the empty (FIG. 5). This interface between the textured surface and the pellet increases the friction between the powder and the empty, decreasing the likelihood of expulsion or damage to the cosmetic (FIG. 9). The textured pellet-empty interface allows a wider scope of draft angle, corner reinforcement, and compatible powder formulations better than a smooth pellet-empty interface.

In addition to increasing surface friction between empty and pellet, the integrity of the pan is further improved by the interaction of the molded fiber empty with the binding agent included in the powder mix. Because the molded fiber is made from interwoven strands of cellulose, it is porous. Surprisingly, this property improves the integrity of the pan by allowing the binding agent to permeate the layers of the cellulosic fiber during compaction. This permeation-based strength is another unexpected reason molded fiber empty’s are able to hold cosmetic powders despite the cosmetic industry dismissal of molded fiber’s feasibility in making cosmetic pans.

This creates a three-phase model for superior adhesion of the pellet within the pan. The outer phase includes only molded fiber, allowing it to maintain its rigidity and clean feel. The second phase is constituted by molded fiber permeated with the binding agent. Their interaction forms a thin liquid-solid colloidal matrix that better maintains the dispersion forces between the cellulosic fibers of the empty and the carbon or silicone chains of the binding agent. The binding agent in the pellet itself (third phase) interacts with the binding agent in the second phase via dispersion forces to chemically bind the pellet to the empty. Importantly, this model makes no use of toxic adhesives, relying on the same binding agents employed in typical pressed powder manufacture.

The ideal binding agent mixture includes a high percentage of low-viscosity molecules that are able to permeate the molded fiber. Some such molecules include various myristic and palmitic acid derivatives, the 250-mer of polyisobutene, or a low-viscosity dimethicone. Natural oils such as jojoba oil or sunflower oil are also effective. Waxes and sterols, which naturally occur in many oils, are also desirable in binding agents, since their active groups can increase intermolecular cohesion within the pan. If a cosmetic formulation requires a low concentration of binding agent or one that has an unsuitably high viscosity, a “priming” step may be included. This step involves lightly spraying the inside of the empty with a binding agent prior to compaction.

Despite the remarkable benefits molded fiber’s permeability has for pan integrity, it also presents a problem for manufacturing due to unwanted staining of the product. The fibers naturally trap the highly pigmented cosmetic powder, producing a staining effect if the powder comes in contact with an unintended area of the cup. This requires the formulation of custom molds and handling protocols to maintain product quality.

Increasing the affinity of the powder for the molded fiber empty compensates for the manufacturing limitation of molded fiber requiring non-zero draft angles. Draft angles are required in molded fiber production, though thermoformed molded fiber technology is able to achieve low single-digit angles in some cases. Optimizing draft angles for each design proved crucial since low draft angles stabilize the pan against lateral forces without compromising the makeup pellet’s affinity for the empty. Although draft angles as high as 30 degrees were found to form stable pans under limited conditions, minimal angles, ranging from 0-5 degrees, were preferred. These minimal draft angles are achievable with thermoformed molded fiber, which was a major factor in its selection for this invention.

The structure of the invention was further stabilized by rounding all corners of the pan (7). The minimum bend radius that maintained the strength of the bend was selected. The bend at the base was selected from a range of 0.1-3 mm, in which 3 mm also represents half the height of the cup. Minimizing bends allowed the structural features to mesh more closely. This was especially crucial for the walls of the container (4), because of their role in maintaining pan integrity. Furthermore, the surface area of both the base (3) and walls (4) were kept low to minimize the risk of flexion of those faces. High area surfaces were strengthened by implementing grooves (8) into its face (FIG. 4).

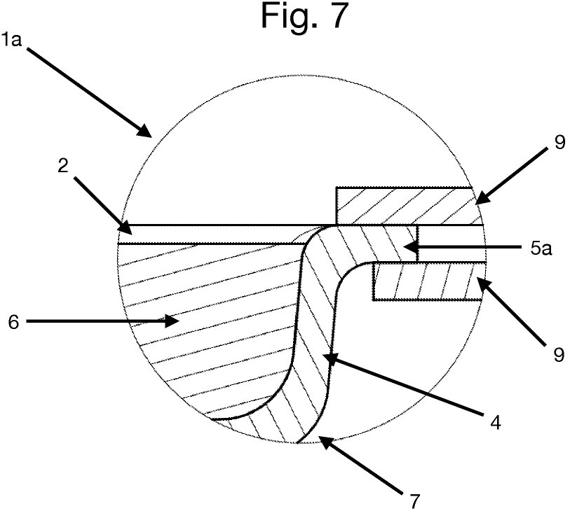

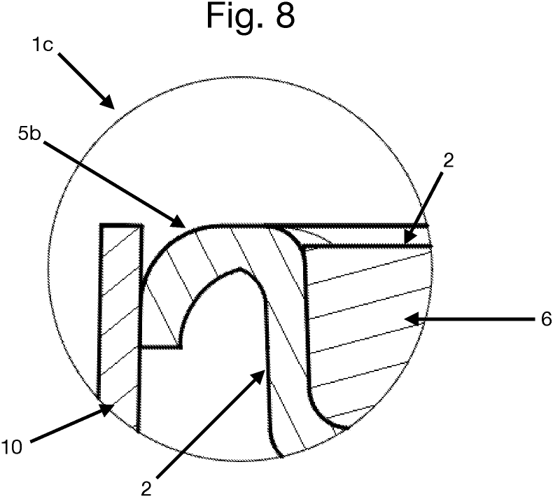

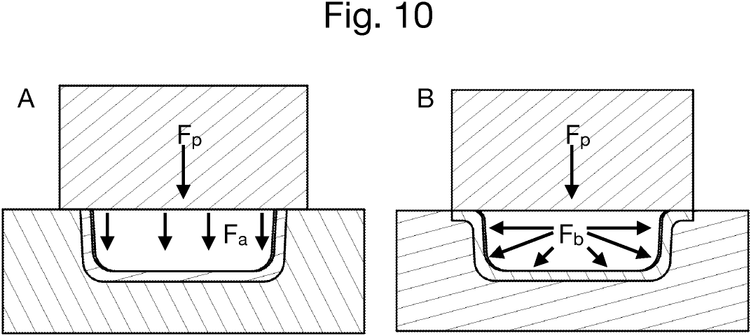

The lip (5) is necessary to maintain structural integrity and allow incorporation into a makeup palette or compact. This important feature is critical for lowering the rigidity requirement of the empty. Molded fiber is much more able to withstand forces perpendicular to its face. However, forces parallel to the face of molded fiber can cause it to buckle. By introducing the lip, no forces are applied to the edge of the molded fiber, which is its weakest point (FIG. 10). The lip can also function as a way to secure the pan according to a variety of models (FIGS. 7, 8). Design iterations 1a and 1b feature a lip that is held in place by a clamping mechanism in which two surfaces, one above and one beneath “sandwich” the lip, thus preventing the pan from moving (FIG. 7). The lip can also form an outer edge to separate and cushion the pellet, making the pan amenable to a fixed fit model (FIG. 6). In this iteration (1c), the lip curves down to become perpendicular to the base (3), the lip can then press out on the sides of a box or other container (10), holding the pan in place (FIG. 8). This form of lip takes advantage of the natural cushioning properties of molded fiber to absorb lateral forces, allowing the lip to flex without distorting the pan.

The most ideal form of the invention is a hexagonal shape (1a), which minimizes the surface area of each of the cup walls without sacrificing storage efficiency. However, a hexagonal shape is not the only form molded fiber can take to provide sufficient rigidity for a pressed-powder cosmetic cup. Further testing has shown that other geometric shapes like circles (1b), ovals, squares (1c), rectangles, and triangles are sufficiently strong to serve as cosmetic cups for this inventions’ purposes. However, supplementing these shapes with grooves (8) or other divots to break up high-area surfaces is recommended to maintain the strength of the pan. Pans with multiple subdivided compartments (FIG. 6) offer a useful variation of the invention to include multiple cosmetic formulations or colors in one pan. In a multi-compartment pan, each subdivision shares at least one lip with another compartment, improving the economy of space.

1. A naturally biodegradable cup for holding pressed-powder cosmetics.

2. A naturally biodegradable cup made out of biodegradable molded fiber material for holding pressed-powder cosmetics.

3. The naturally biodegradable cup according to claim 2, wherein the biodegradable substance comprising the cup is a thermoformed molded fiber material.

4. The naturally biodegradable cup according to claim 2, wherein the cup’s interior has subdivided compartments.

5. The naturally biodegradable cup according to claim 2, wherein the biodegradable substance comprising the cup is a thermoformed molded fiber material and one surface-side of the cup is a textured surface.

6. A naturally biodegradable cup made out of biodegradable thermoformed molded-fiber material for holding pressed-powder cosmetics, where one surface-side of the cup is textured, and the cup’s body includes a range of one to eight side-walls in which the length of any side-wall is greater than the height of the cup.

7. The naturally biodegradable cup according to claim 6, wherein the cup’s interior has subdivided compartments.

8. The biodegradable cup according to claim 2, wherein the cup comprises a molded fiber body including:
A bottom-base, walls projecting out from the bottom-base at a draft angle between 0-30 degrees, an outward-facing lip away from the center of the cup, and an open-ended top-side of the container opposite the bottom-base.

9. The biodegradable cup according to claim 2, wherein the cup comprises a thermoformed molded fiber body in the shape of a hexagon, including:
A bottom-base, walls projecting out from the bottom-base at a draft angle between 0-30 degrees, an outward-facing lip away from the center of the cup that runs within 20 degrees of parallel to the base of the cup for the purpose of securing the cup in the palette, and an open-ended top-side of the container opposite the bottom-base.

10. The biodegradable cup according to claim 2, wherein the cup comprises a molded fiber body including:
A bottom-base, walls projecting out from the bottom-base at a draft angle between 0-30 degrees, an outward-facing lip away from the center of the cup that curves perpendicular to the base of the cup to resist lateral pressure, and an open-ended top-side of the container opposite the bottom-base.

11. The biodegradable cup according to claim 2, wherein the cup comprises a molded fiber body including:
A bottom-base, walls that are 1-15 mm in height projecting out from the bottom-base at a draft angle between 0-30 degrees, an outward-facing lip away from the center of the cup, and an open-ended top-side of the container opposite the bottom-base.

12. The biodegradable cup according to claim 2, wherein the cup comprises a molded fiber body including:
A bottom-base, a range of three to eight side-walls projecting out from the bottom-base at a draft angle between 0-30 degrees in which the length of any side is greater than the height of the cup, an outward-facing lip away from the center of the cup, and an open-ended top-side of the container opposite the bottom-base.

13. The biodegradable cup according to claim 2, wherein the cup comprises a molded fiber body including:
A bottom-base, walls projecting out from the bottom-base at a draft angle between 0-30 degrees terminating in an outward-facing lip away from the center of the cup, and an open-ended top-side of the container opposite the bottom-base where the open-ended top forms a polygon in which the length of the radius of the tangentially inscribed circle is greater than the height of the cup.

14. The biodegradable cup according to claim 2, wherein the cup is a molded fiber body in a geometric shape selected from the group consisting of a hexagon, a square, a rectangle, a triangle, a circle, an oval, a pentagon, a heptagon, and an octagon, and where said cup includes:
A bottom-base, walls projecting out from the bottom-base at a draft angle between 0-30 degrees, an outward-facing lip away from the center of the cup, and an open-ended top-side of the container opposite the bottom-base.
